(19) United States
(12) Patent Application Publication
(10) Pub. No.: US 2007/0127361 A1
(43) Pub. Date: Jun. 7, 2007

(54) OFDM TRANSMISSION APPARATUS, OFDM RECEPTION APPARATUS, AND METHOD

(75) Inventors: Hideo Kasami, Yokohama-Shi (JP); Hidehiro Matsuoka, Yokohama-Shi (JP); Noritaka Deguchi, Kawasaki-Shi (JP); Seiichiro Horikawa, Kawasaki-Shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Minato-ku (JP)

(21) Appl. No.: 11/531,190

(22) Filed: Sep. 12, 2006

(30) Foreign Application Priority Data
Dec. 6, 2005 (JP) 2005-352186

(51) Int. Cl. H04J 11/00

(52) U.S. Cl. 370/208

(57) ABSTRACT

According to an aspect of the present invention, there is provided with an OFDM (Orthogonal Frequency Division Multiplexing) transmission apparatus, including: a subcarrier modulator configured to perform subcarrier modulation on a data sequence to generate subcarrier modulated signals; an IFFT unit configured to perform IFFT (Inverse Fast Fourier Transform) processing on the subcarrier modulated signals to generate a first OFDM symbol having a length corresponding to the number of FFT points at the IFFT processing; a symbol length shortener configured to obtain a part of the generated first OFDM symbol as a second OFDM symbol; and a transmitter configured to transmit the second OFDM symbol obtained to an other communication apparatus.

### CROSS-REFERENCE TO RELATED APPLICATIONS

This application is based upon and claims the benefit of priority from the prior Japanese Patent Applications No. 2005-352186 filed on Dec. 6, 2005, the entire contents of which are incorporated herein by reference.

### BACKGROUND OF THE INVENTION

1. Field of the Invention

The present invention relates to an OFDM (Orthogonal Frequency Division Multiplexing) transmission apparatus, an OFDM reception apparatus, and method, for example, to a technique of adaptive modulation in an OFDM transmission system.

2. Related Art

In typical OFDM transmission apparatus, a data sequence which has subjected to subcarrier modulation is subsequently subject to IFFT (Inverse Fast Fourier Transform) to generate one effective symbol. Furthermore, a guard interval is added to a head of this effective symbol as a measure against a delayed wave. On the other hand, in the ODFM reception apparatus, the guard interval is removed from received signals, and a resultant signals are subjected to FFT and subcarrier demodulation. Thereby, the data sequence is reproduced. In adaptive modulation in the conventional OFDM system, a method of changing the modulation scheme for the subcarrier is typical, and a method of changing the guard interval length is also proposed. However, the above-described adaptive modulation method has a problem that the degree of freedom in transmission rate change is not sufficient.

### SUMMARY OF THE INVENTION

According to an aspect of the present invention, there is provided with an OFDM (Orthogonal Frequency Division Multiplexing) transmission apparatus comprising:

a subcarrier modulator configured to perform subcarrier modulation on a data sequence to generate subcarrier modulated signals;

an IFFT unit configured to perform IFFT (Inverse Fast Fourier Transform) processing on the subcarrier modulated signals to generate a first OFDM symbol having a length corresponding to the number of FFT points at the IFFT processing;

a symbol length shortener configured to obtain a part of the generated first OFDM symbol as a second OFDM symbol; and

a transmitter configured to transmit the second OFDM symbol obtained to an other communication apparatus.

According to an aspect of the present invention, there is provided with an OFDM reception apparatus comprising:

a receiver configured to receive signals from an other communication apparatus;

a linear transformer configured to perform linear transform on a third OFDM symbol which is the received signals of a first symbol length to obtain subcarrier signals and;

a subcarrier demodulator configured to perform subcarrier demodulation on the subcarrier signals to obtain a data sequence.

According to an aspect of the present invention, there is provided with an OFDM reception method comprising:

receiving signals from an other communication apparatus;

performing linear transform on a third OFDM symbol which is the received signals of a first symbol length to obtain subcarrier signals and;

performing subcarrier demodulation on the subcarrier signals to obtain a data sequence.

### BRIEF DESCRIPTION OF THE DRAWINGS

FIG. 1 is a block diagram of an OFDM transmission apparatus according to a first embodiment;

FIG. 2 is a concept diagram of an OFDM transmission signal according to a first embodiment;

FIG. 3 is a diagram showing an example of communication between a base station and a terminal according to a first embodiment;

FIG. 4 is a diagram showing a frame configuration according to a first embodiment;

FIG. 5 is a diagram showing a frame configuration according to a first embodiment;

FIG. 6 is a diagram showing contents of a symbol on a head side according to a first embodiment;

FIG. 7 is a diagram showing contents of a symbol on a head side of a packet according to first and second embodiments;

FIG. 8 is a diagram showing an example of communication between terminals according to a first embodiment;

FIG. 9 is a diagram showing an example of communication between terminals according to a first embodiment;

FIG. 10 is a block diagram of an OFDM reception apparatus according to a first embodiment;

FIG. 11 is a graph showing a bit error rate according to a first embodiment;

FIG. 12 is a diagram showing another configuration example of an OFDM transmission apparatus according to a first embodiment;

FIG. 13 is a diagram showing still another configuration example of an OFDM transmission apparatus according to a first embodiment;

FIG. 14 is a block diagram of an OFDM reception apparatus according to a second embodiment;

FIG. 15 is a diagram showing an example of communication between terminals according to a third embodiment;

FIG. 16 is a block diagram of an OFDM transmission apparatus according to a fourth embodiment;

FIG. 17 is a block diagram of an OFDM reception apparatus according to a fourth embodiment;

FIG. 18 is a diagram showing a downlink frame configuration according to a fifth embodiment;

FIG. 19 is a diagram showing an uplink frame configuration according to a fifth embodiment;

FIG. 20 is a block diagram schematically showing a configuration of an OFDM transmission apparatus according to a fifth embodiment;

FIG. 21 is a diagram showing a frame configuration according to a sixth embodiment;

FIG. 22 is a block diagram of an OFDM reception apparatus according to a sixth embodiment;

FIG. 23 is a concept diagram of an effective symbol with a GI added;

FIG. 24 is a flow chart showing an OFDM transmission method according to an embodiment; and

FIG. 25 is a flow chart showing an OFDM reception method according to an embodiment.

### DETAILED DESCRIPTION OF THE INVENTION

Hereafter, an OFDM (Orthogonal Frequency Division Multiplexing) adaptive modulation scheme according to an embodiment of the present invention will be described in detail with reference to the drawings. Throughout the drawings, the same items are denoted by like numerals, and duplicated description will be omitted.

### First Embodiment

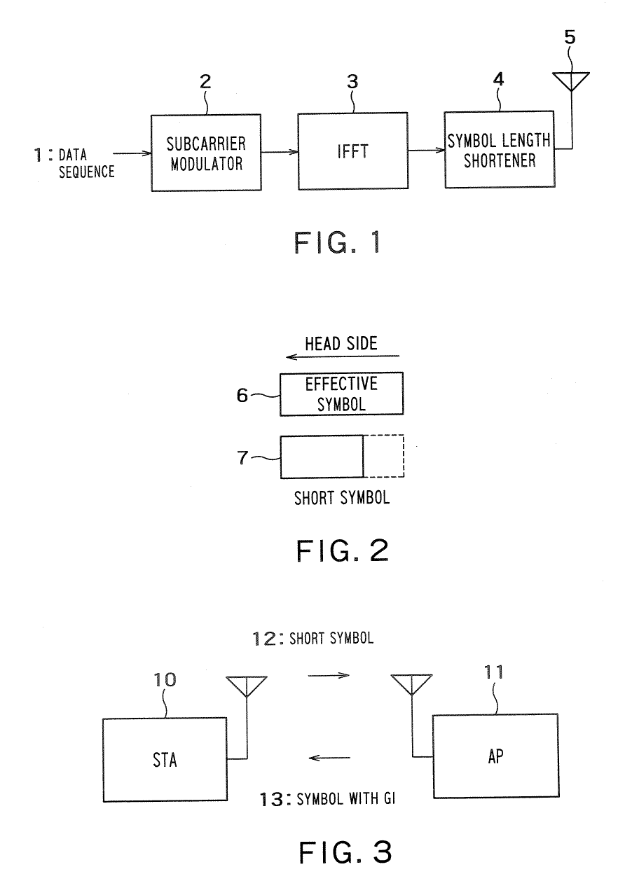

FIG. 1 is a block diagram schematically showing a configuration of an OFDM transmission apparatus according to a first embodiment. The OFDM transmission apparatus performs subcarrier modulation on a data sequence 1 in a subcarrier modulator 2, performs IFFT (Inverse Fast Fourier Transform) processing on subcarrier modulated signals in an IFFT unit 3, and generates an effective symbol 6 shown in FIG. 2. Subsequently, the OFDM transmission apparatus extracts (cuts out) a part on the head side from the effective symbol 6 of the OFDM signals in a symbol length shortener 4. (However, the extracted part is not restricted to the head side.) In the present embodiment, the extracted signals are referred to as short symbol 7 as shown in FIG. 2. The short symbol 7 thus generated is transmitted via an antenna (transmitter) 5. By thus transmitting a part of the effective symbol, the transmission rate can be increased without increasing the processing on the transmission side much. This utilizes the fact that the number of data subcarriers is less than the number of FFT points and the receiver side can reproduce signals by linear conversion, provided that at least signals corresponding to the number of data subcarriers are transmitted.

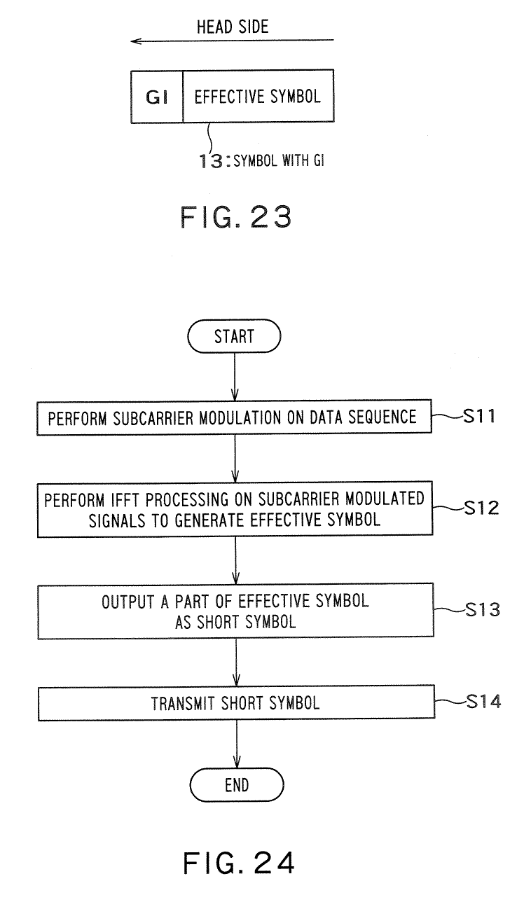

FIG. 3 shows an example of OFDM transmission between a wireless terminal (STA) 10 and a wireless base station (AP) 11. In OFDM transmission (downstream transmission) from the AP 11 to the STA 10, one symbol is formed as an effective symbol with a guard interval (effective symbol with a GI) 13. An example of the effective symbol with a GI 13 is shown in FIG. 23. On the other hand, in OFDM transmission (upstream transmission) from the STA 10 to the AP 11, one symbol is formed as a short symbol 12. The short symbol 12 has a first symbol length, the effective symbol has a second symbol length, and the guard interval has a guard interval length.

The reason why the upstream and downstream transmission schemes thus differ from each other will be described hereafter. In general, reduction of power consumption is more important in the STA 10 than in the AP 11. By causing the STA 10 to transmit the short symbol, therefore, the transmission power in the STA 10 can be reduced. On the other hand, the AP 11 is used in many cases in an environment in which power is always supplied. In the AP 11, therefore, reduction of power consumption does not become important as compared with in the STA 10. Therefore, more reliable communication should be performed by causing the AP 11 to transmit an effective symbol with a GI.

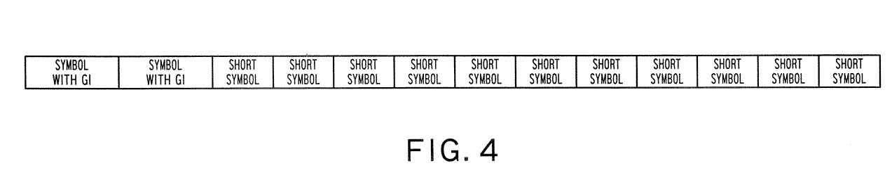

FIG. 4 shows an example of a frame configuration used when packet transmission from the STA 10 to the AP 11 is performed. Two symbols located at the head of a packet are effective symbols with a GI added. Subsequent symbols are short symbols. In order to perform synchronization processing and specify a transmission mode at the head of the packet, the head of the packet needs to be received certainly. Therefore, by using the above frame configuration, the head of the packet can be received certainly.

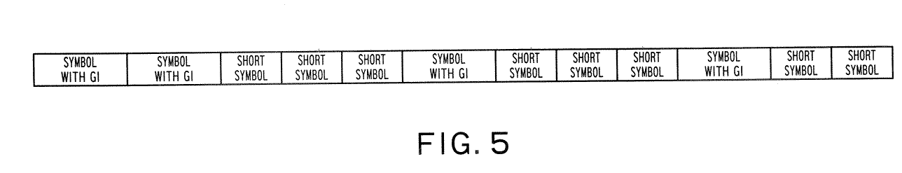

FIG. 5 shows an example of another frame configuration. Besides two effective symbols with a GI located at the head, one effective symbol with a GI is inserted every three short symbols. By adopting such a frame configuration, the synchronization tracking performance can be improved.

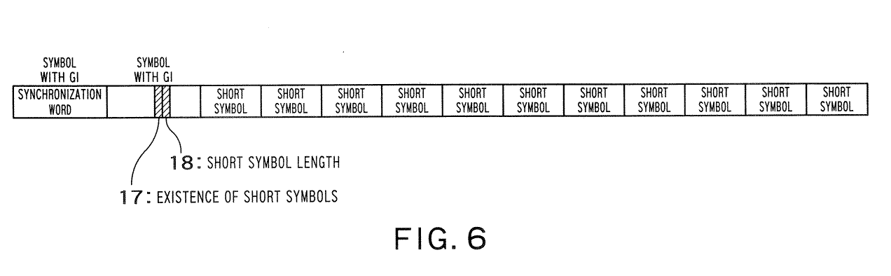

FIG. 6 shows information contained in the two symbols at the head of the packet having the frame configuration shown in FIG. 4. A known synchronization word used for synchronous processing is contained in the first symbol among the two symbols. Information 17 for notifying that short symbols are contained in this packet and information 18 concerning the short symbol length are contained in the second symbol.

By causing the head side symbols to contain such information, even a conventional reception apparatus which does not correspond to short symbols can receive the head symbols of the packet. As a result, it becomes possible for the reception side to disregard short symbols subsequent to the two head symbols or notify the transmission side that the reception side does not correspond to short symbols. Furthermore, the transmission side can change whether to transmit short symbols by taking a packet as the unit. Furthermore, the short symbol length can also be changed by taking a packet as the unit.

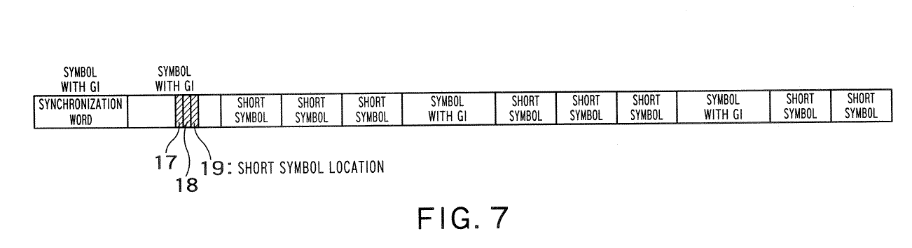

FIG. 7 shows information contained in the two symbols at the head of the packet having the frame configuration shown in FIG. 5, in detail. The synchronization word is contained in the first symbol in the same way as FIG. 6. Besides the information 17 for notifying that short symbols are contained in the packet and information 18 concerning the short symbol length, information 19 concerning short symbol locations is contained in the second symbol. By causing the second symbol to contain the information concerning the short symbol locations, the short symbol locations can be changed by taking a packet as the unit.

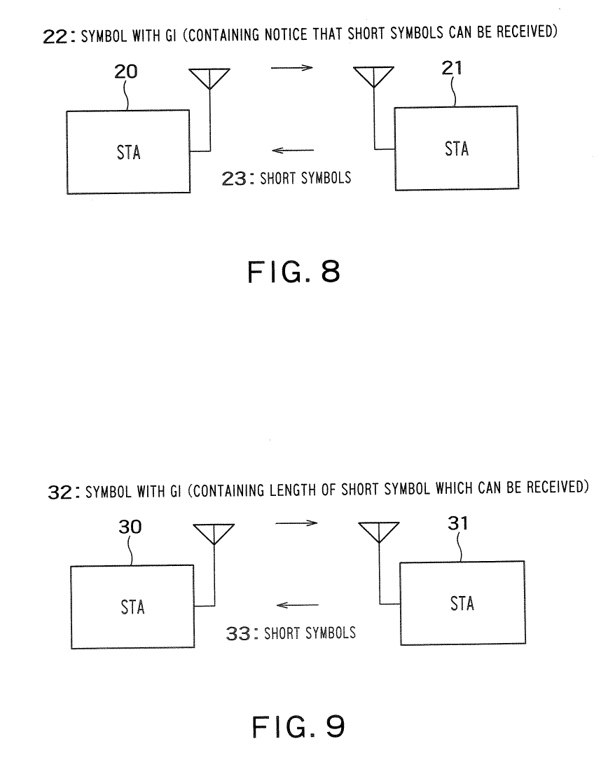

Heretofore, the example in which communication is performed between the AP and STA has been described. However, FIG. 8 shows an example in which communication is performed between STAs. A STA 20 sends a notice to the effect that short symbols can be received, to a STA 21 by using an effective symbol with a GI 22. Upon receiving this notice, the STA 21 performs data transmission by using short symbols 23. By going through such a procedure, it can be avoided for the STA 21 to continue to transmit short symbols although the STA 20 cannot perform processing of receiving short symbols.

The example shown in FIG. 8 is based on the supposition that the short symbol length is predetermined. Another example is shown in FIG. 9. A STA 30 sends a notice of a short symbol length which can be received, to a STA 31 by using an effective symbol 32 with a GI. Upon receiving this notice, the STA 31 performs data transmission by using short symbols 33 each having a length which is at least the short symbol length contained in the notice. By going through such a procedure, it is possible to change the length of short symbols to be transmitted, according to the reception capability of the STA 30.

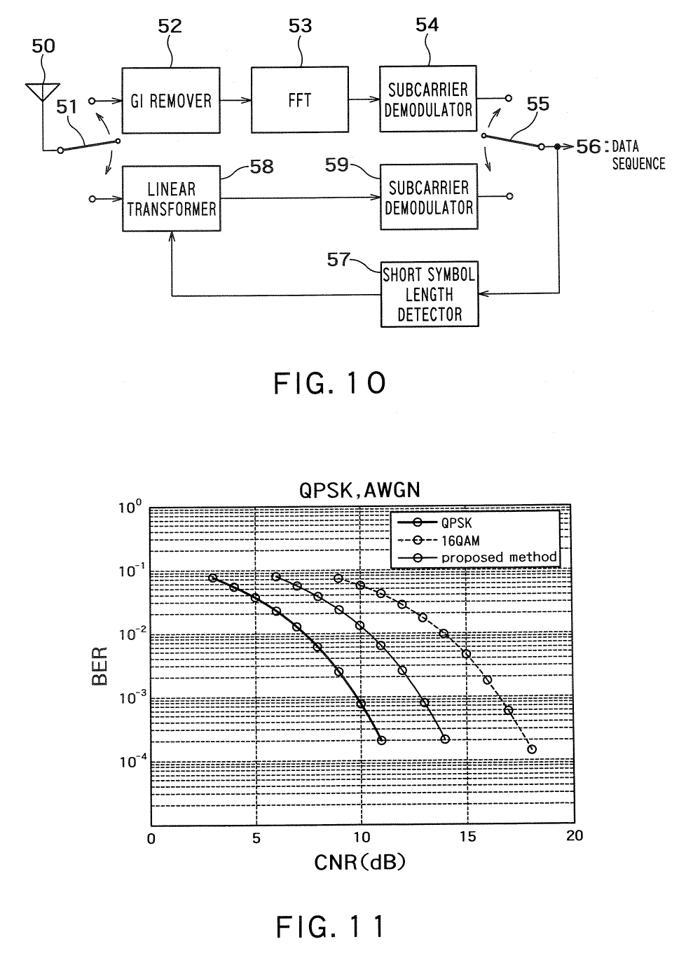

FIG. 10 is a block diagram schematically showing a configuration of a reception apparatus which receives a packet having the frame configuration shown in FIG. 6. One of features of this reception apparatus is that a short symbol length detector 57 which detects a short symbol length is provided and reception processing is performed by handling signals having a length corresponding to the detected short symbol length as one symbol.

First, reception processing of the two symbols located at the head of the packet will be described. In the reception processing of the two symbols located at the head of the packet, a switch 51 is switched to a guard interval remover 52 and a switch 55 is switched to a subcarrier demodulator 54. Signals received via an antenna 50 are input to the guard interval remover 52 via the switch 51 and the guard interval is removed. Subsequently, the signals with the guard interval removed is subjected to Fourier transform in a FFT unit 53 and demodulated in a subcarrier demodulator 54, and a data sequence 56 is reproduced. By using the reproduced data sequence 56, synchronization processing is performed and the short symbol length is detected in a short symbol length detector 57.

Reception processing of the short symbols will now be described. In the reception processing of the short symbols, the switch 51 is switched to a linear transformer 58 and the switch 55 is switched to a subcarrier demodulator 59. Signals received via the antenna 50 are input to the linear transformer 58 via the switch 51. In the linear transformer 58, linear transform processing is performed every signals having the short symbol length detected by the short symbol length detector 57.

Hereafter, an example of linear transform processing will be described.

Denoting the number of FFT points by N, the number of data subcarriers by M, and the short symbol length (the number of points) by L, transmitted short symbols s(n) (n=0, 1, . . . , L−1) are given by (equation 1). It is supposed that the relation N>L≧M is satisfied. X(k) indicates a mapping point on, for example, an IQ constellation. As regards a subcarrier (k=M, M+1, . . . , N−1) to which data is not assigned, X(k)=0.

$$[ \begin{matrix}\begin{matrix}\begin{matrix}s ( 0 ) \\ s ( 1 )\end{matrix} \\ ⋮\end{matrix} \\ s ( L - 1 )\end{matrix} ] = \\ \frac{1}{N} [ \begin{matrix}1 & 1 & ⋯ & 1 \\ 1 & exp ( j \frac{2 π}{N} ) & ⋯ & exp ( j \frac{2 π ( M - 1 )}{N} ) \\ ⋮ & ⋮ & ⋰ & ⋮ \\ 1 & exp ( j \frac{2 π ( L - 1 )}{N} ) & ⋯ & exp ( j \frac{2 π ( M - 1 ) ( L - 1 )}{N} )\end{matrix} ] \cdot \\ [ \begin{matrix}\begin{matrix}\begin{matrix}X ( 0 ) \\ X ( 1 )\end{matrix} \\ ⋮\end{matrix} \\ X ( M - 1 )\end{matrix} ] \qquad ( Equation 1 )$$

The equation 1 can be represented in a matrix form as in (equation 2).
s=A·X (Equation 2)

At this time, a linear matrix in connection with the present embodiment is given by (equation 3).
B=((A·E{X·X^{H}}·A^{H}+pₙI)⁻¹·A·E{X·X^{H}})^{H} (Equation 3)

Here, H denotes a complex conjugate transposition, pₙ denotes supposed noise power, E{ } denotes expected value computation, and I denotes a unit matrix.

Especially, supposing that X(0), X(1), . . . , X(M−1) are noncorrelative to each other and the average power is pₛ, (equation 4) is given.
B=((pₛA·A^{H}+pₙI)⁻¹·pₛA)^{H} (Equation 4)

Furthermore, supposing that pₛ=1 and pₙ=0, (equation 5) is given.
B=((A·A^{H})⁻¹·A)^{H} (Equation 5)

Linear transform is given by (equation 6) using a linear matrix B, where y(n) (n=0, 1, . . . , L−1) are received signals corresponding to transmission signals s(n) (n=0, 1 . . . , L−1).

$$[ \begin{matrix}\begin{matrix}\begin{matrix}{X}^{′} ( 0 ) \\ {X}^{′} ( 1 )\end{matrix} \\ ⋮\end{matrix} \\ {X}^{′} ( M - 1 ) \end{matrix} ] = B \cdot [ \begin{matrix}\begin{matrix}\begin{matrix}y ( 0 ) \\ y ( 0 )\end{matrix} \\ ⋮\end{matrix} \\ y ( L - 1 )\end{matrix} ] \qquad ( Equation 6 )$$

As an example, supposing that the number of FFT points N=4, the number of data subcarriers M=3 and the short symbol length L=3, linear transform is given by (equation 7).

$$[ \begin{matrix}\begin{matrix}{X}^{′} ( 0 ) \\ {X}^{′} ( 1 )\end{matrix} \\ {X}^{′} ( 2 )\end{matrix} ] = [ \begin{matrix}1 - j & 2 & 1 + j \\ 2 & 0 & - 2 \\ 1 + j & - 2 & 1 - j\end{matrix} ] [ \begin{matrix}\begin{matrix}y ( 0 ) \\ y ( 1 )\end{matrix} \\ y ( 2 )\end{matrix} ] \qquad ( Equation 7 )$$

Signals (X′(k)) calculated by the linear transformer 58 are input to the subcarrier demodulator 59, and a subcarrier data sequence 56 corresponding to one symbol is reproduced. The foregoing description is based on the supposition that N>L≧M. If L<M, however, it is conceivable to add a postprocessor, for example, between the linear transformer 58 and the subcarrier demodulator 59 and presume a part of X′(k).

FIG. 11 is a graph showing bit error rate characteristics (BER (Bit Error Rate) characteristics as a function of CNR (Carrier to Noise Ratio)) where QPSK is used as the subcarrier modulation scheme and the linear transform processing described above is performed in an AWGN (Additive White Gaussian Noise) environment. This graph is generated on the basis of a result of simulation performed by the present inventors. It can be confirmed from this graph that the characteristics of the present proposed scheme lie between characteristics of QPSK and 16QAM.

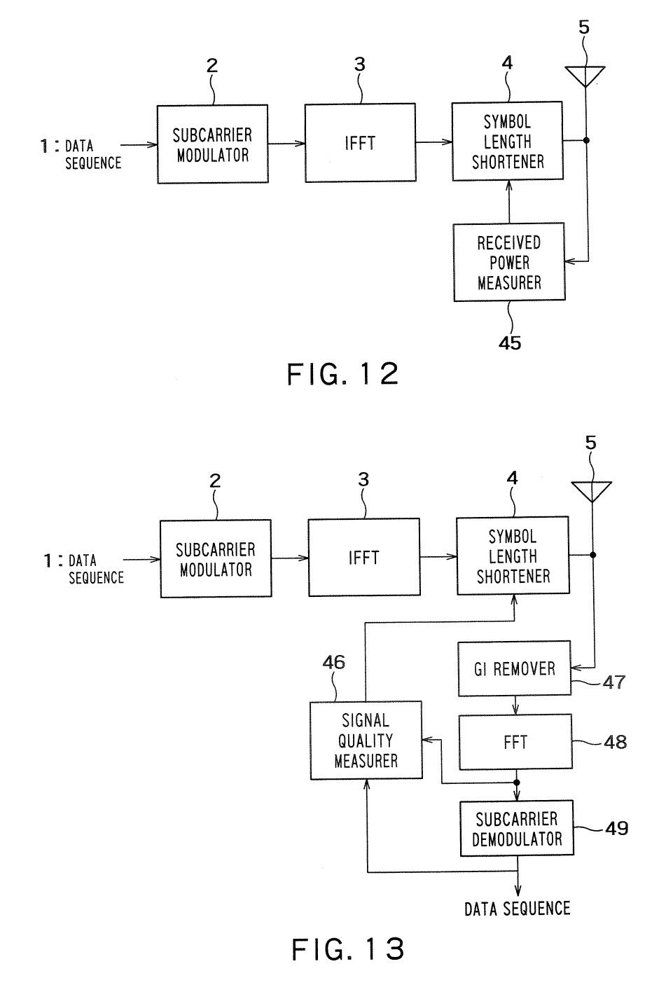

FIG. 12 is a diagram showing another configuration example of an OFDM transmission apparatus. As compared with the OFDM transmission apparatus shown in FIG. 1, a received power measurer 45 is added. The received power measurer 45 measures received power of signals from an opposite apparatus (other communication apparatus) received by the antenna 5. The symbol length shortener 4 determines the short symbol length on the basis of the received power measured by the received power measurer 45. If the received power is low, the symbol length shortener 4 judges the situation of the transmission path to be poor and increases the short symbol length. On the contrary, if the received power is high, the symbol length shortener 4 judges the situation of the transmission path to be good and decreases the short symbol length. As concrete implementation, for example, it is conceivable to determine the short symbol length according to which of ranges sectioned by thresholds the measured received power belongs to.

FIG. 13 shows still another configuration example of an OFDM transmission apparatus. As compared with the OFDM transmission apparatus shown in FIG. 1, a signal quality measurer 46, a GI remover 47, an FFT unit 48 and a subcarrier demodulator 49 are added. The GI remover 47 removes a guard interval from signals received by an antenna (receiver) 5. The FFT unit 48 reconstructs each subcarrier signal. The subcarrier demodulator 49 obtains a data sequence. The signal quality measurer 46 measures a quality (for example, EVM (Error Vector Magnitude)) of the received signals on the basis of subcarrier signals output from the FFT 48. Or the signal quality measurer 46 measures a quality (for example, the bit error rate) of the received signals on the basis of the data sequence output from the subcarrier demodulator 49. The symbol length shortener 4 determines the short symbol length according to the quality of the received signals measured by the signal quality measurer 46. If the quality of the received signals is low, the symbol length shortener 4 judges the situation of the transmission path to be poor and increases the short symbol length. On the contrary, if the quality is high, the symbol length shortener 4 judges the situation of the transmission path to be good and decreases the short symbol length. As concrete implementation, it is conceivable to determine the short symbol length according to which of ranges sectioned by thresholds the quality of the received signals belongs to, in the same way as the case shown in FIG. 12.

FIG. 24 is a flow chart showing an OFDM transmission method executed in the OFDM transmission apparatus according to the present embodiment. A computer may be caused to execute a program which describes processing performed at steps shown in FIG. 24.

First, a data sequence is subjected to subcarrier modulation (S11). Subsequently, the subcarrier modulated signals is subjected to IFFT processing to generate an effective symbol (S12). The effective symbol has a length corresponding to the number of FFT points at the IFFT processing. Subsequently, a part of the effective symbol which has at least a length corresponding to the number of data subcarriers to which data is assigned is output as a short symbol (S13). The number of the data subcarriers is less than the number of FFT points. The output short symbol is transmitted to the reception apparatus (S14).

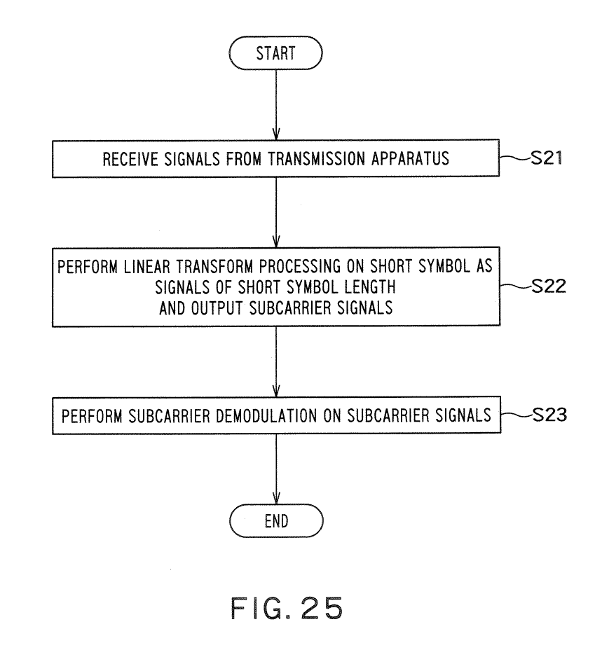

FIG. 25 is a flow chart showing an OFDM reception method executed in the OFDM reception apparatus according to the present embodiment. A computer may be caused to execute a program which describes processing performed at steps shown in FIG. 25.

The signals from the transmission apparatus is received (S21). The short symbol as received signals of certain symbol length (short symbol length) is subjected to linear transform processing, and subcarrier signals are output (S22). And the output subcarrier signals are subjected to subcarrier demodulation to obtain a data sequence (S23).

In the first embodiment of the present invention, short symbols can also be received and transmitted besides ordinary OFDM symbols (effective symbols with a GI added) as heretofore described. It becomes possible to change the transmission rate more finely by changing the short symbol length.

### Second Embodiment

FIG. 14 is a block diagram schematically showing a configuration of an OFDM reception apparatus according to a second embodiment of the present invention. The OFDM reception apparatus according to the second embodiment differs from the OFDM reception apparatus according to the first embodiment in that a short symbol location detector 60 is added. In the OFDM reception apparatus according to the first embodiment, it is supposed that locations of the short symbols are predetermined. In the present embodiment, however, locations of short symbols can be changed by taking a packet as the unit. In other words, it is supposed that the reception apparatus shown in FIG. 14 receives the packet having the frame configuration shown in FIG. 7.

The short symbol location detector 60 detects locations of short symbols on the basis of a data sequence reproduced from the second symbol from the packet head in FIG. 7. According to the detected short symbol locations, the switch 51 is switched to the guard interval remover 52 with respect to a symbol with a GI added whereas the switch 51 is switched to the linear transformer 58 with respect to a short symbol.

In this manner, in the second embodiment of the present invention, it becomes possible to change the locations of the short symbols by taking a packet as the unit as heretofore described.

### Third Embodiment

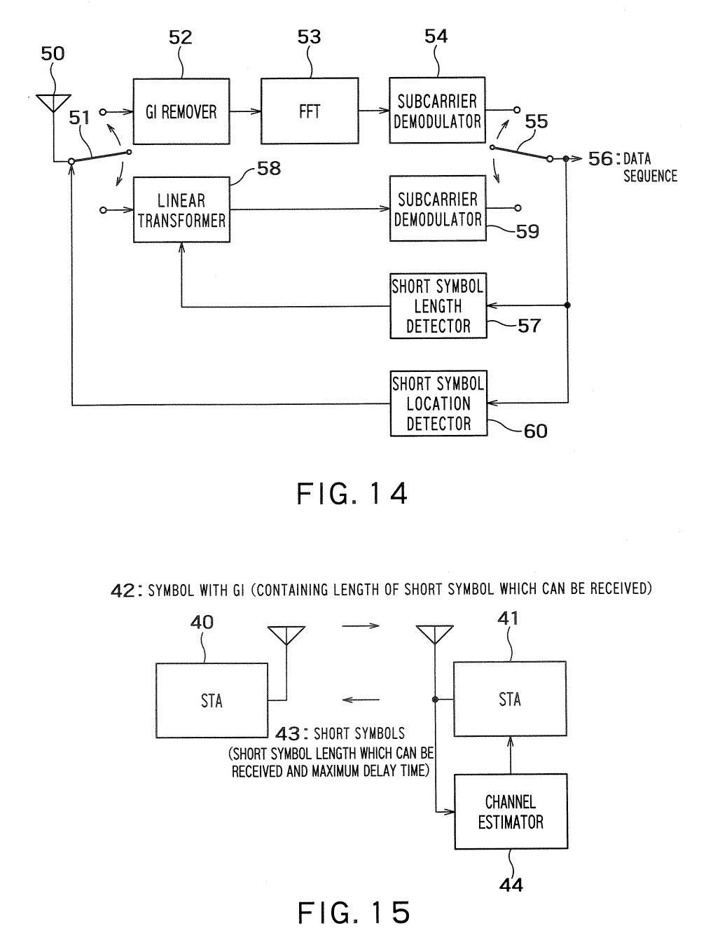

FIG. 15 is a diagram showing an example of communication between terminals according to a third embodiment of the present invention. The third embodiment differs from the first embodiment in that the transmission side determines the short symbol length considering the delay time of the delay wave.

A STA 40 sends a notice of a short symbol length which can be received, to a STA 41 by using an effective symbol with a GI. Upon receiving this notice, the STA 41 performs data transmission by using short symbols each having at least the short symbol length contained in the notice. The STA 41 includes a channel estimator (delay time estimator) 44 which estimates the delay time of the delay wave, and estimates a maximum delay time of signals transmitted from the STA 40. Subsequently, the STA 41 generates and transmits short symbols 43 each having a length obtained by adding the estimated maximum delay time to the short symbol length contained in the notice.

In the third embodiment of the present invention, it is possible to change the short symbol length according to the delay time of the delay wave and avoid inter-symbol interference caused by the delay wave, as heretofore described.

### Fourth Embodiment

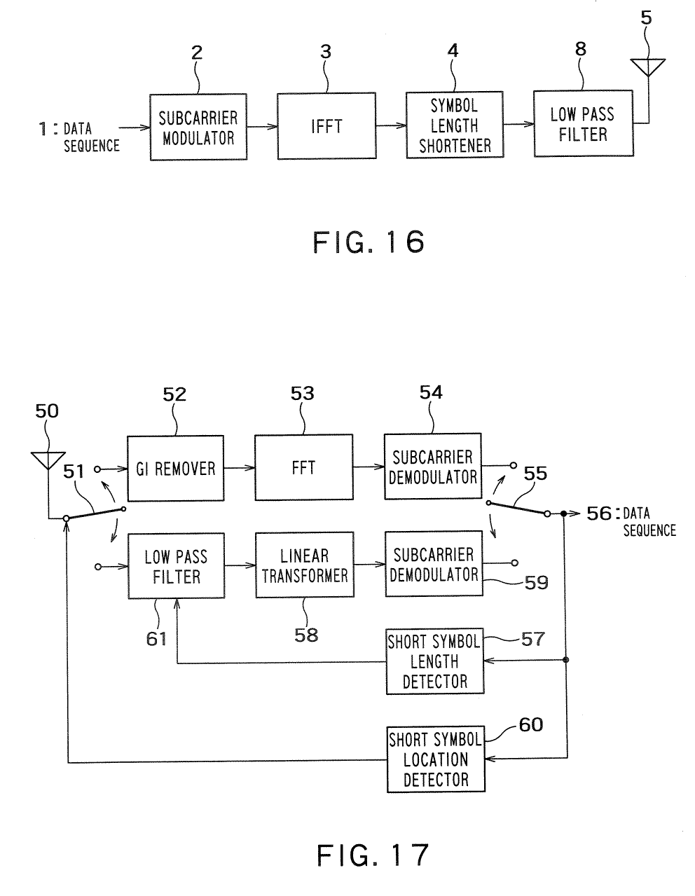

FIG. 16 is a block diagram schematically showing a configuration of an OFDM transmission apparatus according to a fourth embodiment of the present invention. FIG. 17 is a block diagram schematically showing a configuration of an OFDM reception apparatus according to a fourth embodiment of the present invention. The fourth embodiment differs from the first embodiment in that a low pass filter 8 is added to the OFDM transmission apparatus and a low pass filter 61 is added to the OFDM reception apparatus.

If the symbol length is shortened by a symbol length shortener 4 on the transmission side, there is a possibility that the transmission spectrum will change (spread) and a spectrum mask of the system will not be satisfied. Therefore, the spectrum is shaped by removing high frequency components in the low pass filter 8 so as to satisfy the spectrum mask. On the reception side as well, the low pass filter 61 is provided in a stage preceding the linear transformer 58 to improve the signal-to-noise ratio. The low pass filter 61 performs processing on received signals having a length corresponding to the short symbol length and outputs signals after the processing to the linear transformer 58.

### Fifth Embodiment

In the present embodiment, the case where short symbols are applied to a downlink of a cellular system will be described.

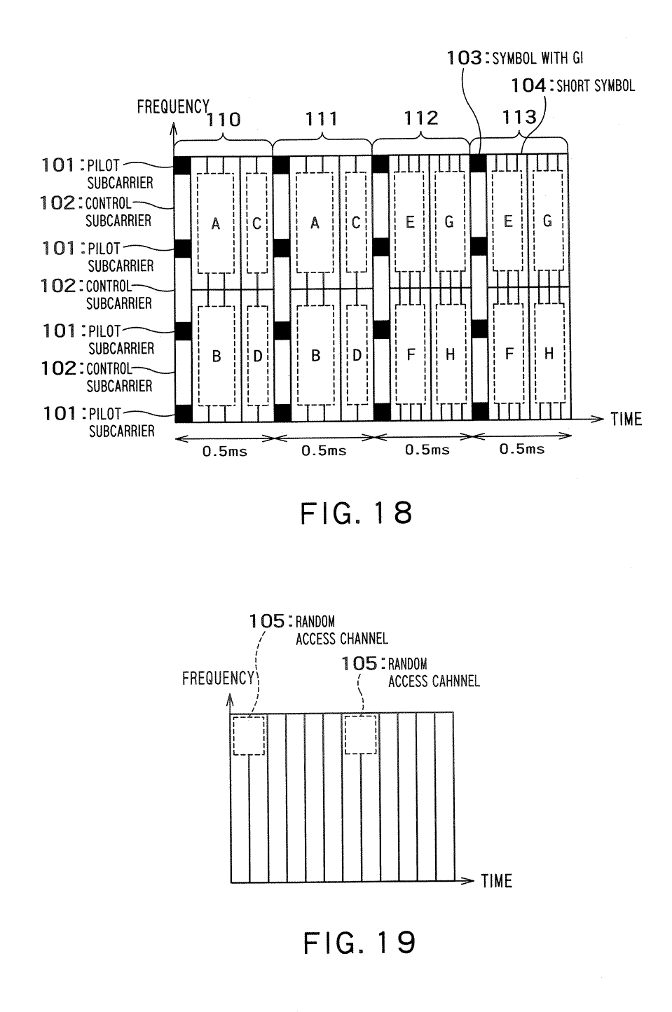

FIG. 18 shows a frame configuration of a downlink. In the present example, one frame includes four subframes. Among four subframes 110, 111, 112 and 113 shown in FIG. 18, each of the former two subframes 110 and 111 includes only an effective symbol 103 with a GI. Each of the latter two subframes 112 and 113 includes short symbols 104 except one head symbol. The one head symbol is an effective symbol with a GI added 103. The head symbol of each subframe includes pilot subcarriers 101 for synchronization and control subcarriers 102 for notifying each terminal (user) of channel assignment and a frame configuration. In the subframes 110 and 111, channels are assigned to terminals A, B, C and D. In the subframes 112 and 113, channels are assigned to terminals E, F, G and H. Channel assignment request from a terminal is carried out by a random access channel 105 in an uplink frame configuration shown in FIG. 19. In FIG. 18, each subframe length is made constant. By doing so, spacing between head symbols of subframes becomes constant, and the configuration of the whole system is simplified.

Parameters common to all subframes are as follows.

Sample frequency: 30.72 MHz

FFT size: 2048

The number of occupied subcarriers: 1201

Subframe length: (1/30.72 MHz)*(2048+512)*6=0.5 ms

Parameters of the subframes 110 and 111 are as follows.

Guard interval size: 512

Size of symbol with guard: 2560

The number of OFDM symbols every subframe: 6

Parameters of the subframes 112 and 113 are as follows. “399” is a adjusted value to make each subframe length constant.

Short symbol size: 1201+399=1600

The number of OFDM symbols every subframe: one symbol with GI+eight short symbols

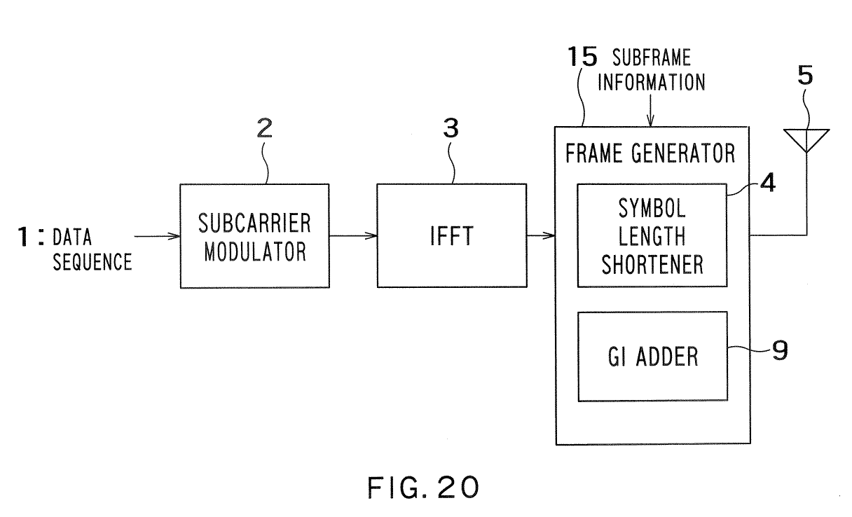

FIG. 20 is a block diagram schematically showing a configuration of an OFDM transmission apparatus according to the present embodiment.

A frame generator 15 is disposed between an IFFT unit 3 and an antenna 5. The frame generator 15 includes a symbol length shortener 4 and a GI adder 9. Subframe information indicating a symbol configuration (an arrangement pattern of effective symbols with a GI and short symbols) is input to the frame generator 15. According to the input subframe information, the frame generator 15 performs processing on effective symbols input from the IFFT unit 3. In other words, if the input effective symbol is a symbol to be transmitted as an effective symbol with a GI, an effective symbol with a GI is generated by the GI adder 9. If the input effective symbol is a symbol to be transmitted as a short symbol, a short symbol is generated by the symbol length shortener 4.

As heretofore described, the present embodiment can also be applied to a downlink in a cellular system by disposing short symbols in a subframe so as to make the subframe length constant.

### Sixth Embodiment

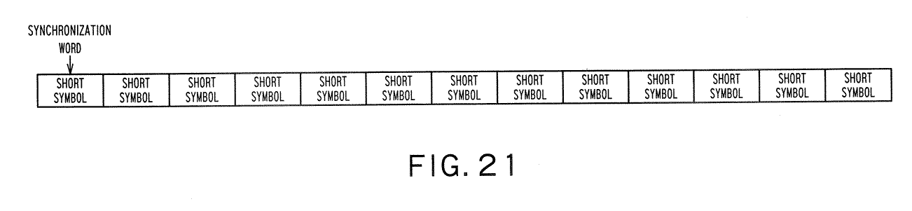

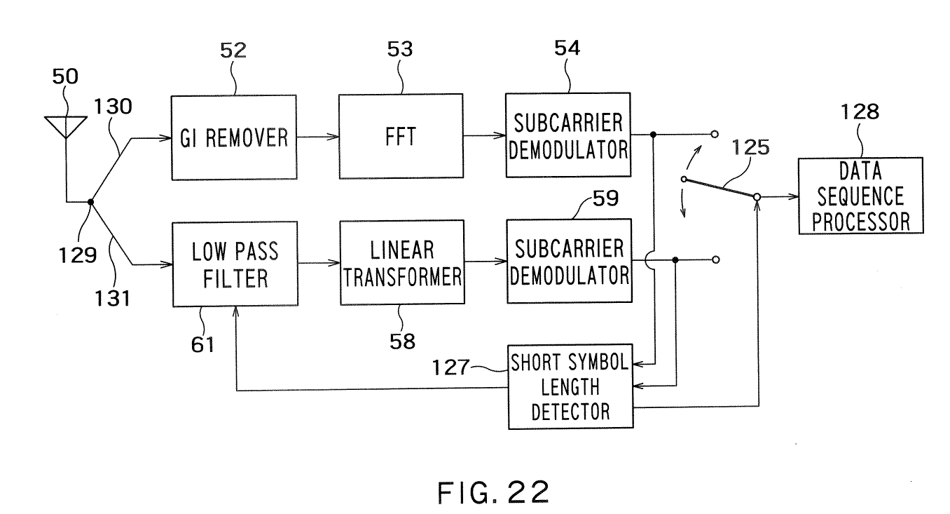

FIG. 21 is a diagram showing a frame configuration according to a sixth embodiment of the present invention. FIG. 22 is a block diagram schematically showing a configuration of an OFDM reception apparatus according to the sixth embodiment of the present invention.

As appreciated from FIG. 21, short symbols are included from the head symbol of the frame unlike the first embodiment. On the other hand, the OFDM reception apparatus shown in FIG. 22 performs reception processing with respect to both an effective symbol with a GI and a short symbol, determines whether received signals is an effective symbol with a GI or a short symbol by using a short symbol detector (pattern comparator) 127, and switches over a switch 125 according to a result of the determination. More details will now be described.

Signals received at an antenna 50 are distributed to a first path 130 and a second path 131 by a signal distributor (divider) 129. That is to say, the signals are divided into first signals and second signals. The first path 130 is connected to a GI remover 32. The second path 131 is connected to a low pass filter 61. A data sequence is output from each of a subcarrier demodulator 54 and a subcarrier demodulator 59. These data sequences are input to the short symbol detector 127. The short symbol detector 127 compares these data sequences with an already known synchronization word respectively. The short symbol detector 127 controls the switch 125 so as to connect a subcarrier modulator which has output a data sequence coinciding with the synchronization word to a data sequence processor 128. Here, the case where only one symbol including the synchronization word is located at the head of the packet has been described. However, it is also possible to improve the decision precision of the above-described processing by using a plurality of symbols including the synchronization word.

As heretofore described, in the sixth embodiment of the present invention, short symbols can be included from the head symbol of the frame.

### Other Embodiments

Besides the foregoing description, in the present invention, a method of preferentially changing a short symbol to an effective symbol with a GI instead of reducing the number of modulation multi-values in the subcarrier modulation in the case of lowering the transmission rate is conceivable. For example, in the case of lowering the transmission rate for subcarrier modulation scheme 64QAM+short symbols, subcarrier modulation scheme 64QAM+an effective symbol with a GI is used instead of subcarrier modulation scheme 16QAM+short symbols.

The first to seventh embodiments have been described by taking wireless communication as an example. However, the present invention can be applied to the case of wired communication as well. As the wired communication, for example, PLC (Power Line Communication) and ADSL (Asymmetric Digital Subscriber Line) communication can be mentioned.

Furthermore, functions executed by various apparatuses according to the first to seventh embodiments may also be implemented by causing a computer to execute a communication program. The communication program may be recorded in a computer readable medium.

What is claimed is:

1. An OFDM (Orthogonal Frequency Division Multiplexing) transmission apparatus comprising:
a subcarrier modulator configured to perform subcarrier modulation on a data sequence to generate subcarrier modulated signals;
an IFFT unit configured to perform IFFT (Inverse Fast Fourier Transform) processing on the subcarrier modulated signals to generate a first OFDM symbol having a length corresponding to the number of FFT points at the IFFT processing;
a symbol length shortener configured to obtain a part of the generated first OFDM symbol as a second OFDM symbol; and
a transmitter configured to transmit the second OFDM symbol obtained to an other communication apparatus.

2. The apparatus according to claim 1, wherein the second OFDM symbol has at least a length corresponding to the number of data subcarriers to which data is actually assigned, the number of the data subcarriers being less than the number of the FFT points.

3. The apparatus according to claim 1, further comprising:
a receiver configured to receive signals containing information concerning a length of the second OFDM symbol from the other communication apparatus,
wherein the symbol length shortener determines a length of the second OFDM symbol in accordance with the information contained in the signals received.

4. The apparatus according to claim 1, further comprising:
a receiver configured to receive signals from the other communication apparatus; and
a power measurer configured to measure a power of the signals received,
wherein the symbol length shortener determines a length of the second OFDM symbol on the basis of the power measured.

5. The apparatus according to claim 2, further comprising:
a receiver configured to receive signals from the other communication apparatus; and
a delay time estimator configured to estimate a delay time of a delay wave of the signals received,
wherein the second OFDM symbol has at least a length obtained by adding a length corresponding to the number of the data subcarriers and a length corresponding to the delay time estimated.

6. The apparatus according to claim 1, further comprising:
a receiver configured to receive signals from the other communication apparatus; and
a signal quality measurer configured to measure a quality of the signals received,
wherein the symbol length shortener determines a length of the second OFDM symbol on the basis of the quality measured.

7. The apparatus according to claim 1, further comprising:
a guard interval adder configured to add a guard interval to the generated first OFDM symbol and pass the first OFDM symbol with the guard interval to the transmitter,
wherein the IFFT unit passes a certain number of first OFDM symbols to the guard interval adder among plural first OFDM symbols generated for a packet transmission from a head side of the packet transmission, and passes remaining first OFDM symbols to the symbol length shortener.

8. The apparatus according to claim 7, wherein the IFFT unit passes the remaining first OFDM symbols to not the symbol length shortener but the guard interval adder at predetermined symbol intervals.

9. The apparatus according to claim 7, wherein the first OFDM symbol with the guard interval contains a notice to the effect that second OFDM symbols will be transmitted to the other communication apparatus.

10. The apparatus according to claim 9, wherein the first OFDM symbol with the guard interval further contains information concerning a length of the second OFDM symbol.

11. The apparatus according to claim 10, wherein the first OFDM symbol with the guard interval contains information concerning locations of the second OFDM symbols in the packet transmission.

12. The apparatus according to claim 1, further comprising:
a receiver configured to receive signals containing information as to whether the second OFDM symbol can be accepted, from the other communication apparatus; and
a guard interval adder configured to add a guard interval to the first OFDM symbol generated by the IFFT unit and pass the first OFDM symbol with the guard interval to the transmitter,
wherein if the signals indicate that the second OFDM symbol cannot be accepted, the IFFT unit passes the generated first OFDM symbol to the guard interval adder, whereas if the signals indicate that the second OFDM symbol can be accepted, the IFFT unit passes the generated first OFDM symbol to the symbol length shortener.

13. The apparatus according to claim 1, further comprising a low pass filter between the symbol length shortener and the transmitter.

14. The apparatus according to claim 1, further comprising:
a guard interval adder configured to add a guard interval to the first OFDM symbol generated by the IFFT unit; and
a frame generator configured to generate a first subframe containing only first OFDM symbols with the guard interval and a second subframe containing at least one second OFDM symbol and at least one first OFDM symbol with a guard interval, by using the guard interval adder and the symbol length shortener.

15. An OFDM reception apparatus comprising:
a receiver configured to receive signals from an other communication apparatus;
a linear transformer configured to perform linear transform on a third OFDM symbol which is the received signals of a first symbol length to obtain subcarrier signals and;
a subcarrier demodulator configured to perform subcarrier demodulation on the subcarrier signals to obtain a data sequence.

16. The apparatus according to claim 15, further comprising:
a guard interval remover configured to remove signals of a guard interval length from the received signals of a second symbol length to obtain a fourth OFDM symbol;
an FFT unit configured to perform FFT processing on the fourth OFDM symbol to obtain subcarrier signals;
a further subcarrier demodulator configured to perform subcarrier demodulation on the subcarrier signals obtained by the FFT unit to obtain a data sequence;
a symbol length detector configured to detect information concerning the first symbol length from the data sequence obtained by the further subcarrier demodulator; and
a switch configured to switch a connection destination of the receiver between the guard interval remover and the linear transformer.

17. The apparatus according to claim 16, further comprising
a symbol location detector configured to detect information concerning locations of third OFDM symbols in a packet transmission in which the third OFDM symbols and at least one of the fourth OFDM symbol are transmitted from the other communication apparatus, from the data sequence obtained by the further subcarrier demodulator,
wherein the switch switches the connection destination of the receiver in accordance with the detected information.

18. The apparatus according to claim 15, further comprising a low pass filter at a stage preceding the linear transformer.

19. The apparatus according to claim 15, further comprising:
a signal divider configured to divide the signals received by the receiver to first signals and second signals and input the second signals to the linear transformer;
a guard interval remover configured to be input with the first signals, and remove signals of a guard interval length from the first signals of a second symbol length to obtain a fourth OFDM symbol;
an FFT unit configured to perform FFT processing on the fourth OFDM symbol to obtain subcarrier signals;
a further subcarrier demodulator configured to perform subcarrier demodulation on the subcarrier signals to obtain a data sequence;
a data sequence processor configured to process the data sequence;
a pattern comparator configured to compare the data sequences obtained from the subcarrier demodulator and the further subcarrier demodulator with an already known pattern respectively; and
a switch configured to connect one of the subcarrier demodulator and the further subcarrier demodulator to the data sequence processor on a basis of a comparison result.

20. An OFDM reception method comprising:
receiving signals from an other communication apparatus;
performing linear transform on a third OFDM symbol which is the received signals of a first symbol length to obtain subcarrier signals and;
performing subcarrier demodulation on the subcarrier signals to obtain a data sequence.
